(19) United States
(12) Patent Application Publication
(10) Pub. No.: US 2025/0260990 A1
(43) Pub. Date: Aug. 14, 2025

(54) MITIGATION OF TOKEN REUSE ATTACKS

(71) Applicant: Intel Corporation, Santa Clara, CA (US)

(72) Inventor: Abhijeet Ashok Kolekar, Hillsboro, OR (US)

(21) Appl. No.: 19/197,810

(22) Filed: May 2, 2025

Related U.S. Application Data
(60) Provisional application No. 63/644,417, filed on May 8, 2024.

(51) Int. Cl. H04W 12/122; H04W 12/06; H04W 12/082

(52) U.S. Cl. CPC H04W 12/122; H04W 12/06; H04W 12/082

(57) ABSTRACT

Systems and methods are disclosed for secure token verification. A Network Repository Function (NRF) receives an access token request from a Network Function (NF) Service Consumer and generates an access token with enhanced security claims of authorized producer NF instances and a token issuance timestamp. The NF Service Producer verifies the token by checking that an NRF ID matches an authorized ID in the token and comparing the token issuance timestamp against the last authorization update timestamp. The NRF maintains a Token Revocation List (TRL) that records identifiers of revoked tokens. For a NF discovery request, the NRF cross-verifies attributes in the request with an attribute in the NF profile of the NF Service Consumer to prevent discovery bypass attacks.

### PRIORITY CLAIM

This application claims the benefit of priority to U.S. Provisional Patent Application Ser. No. 63/644,417, filed May 8, 2024, which is incorporated herein by reference in its entirety.

### TECHNICAL FIELD

Embodiments pertain to wireless networks and wireless communications. Some embodiments relate to telecommunications network security and prevention of token reuse attacks in core networks.

### BACKGROUND

Mobile communication has evolved significantly from early voice systems to highly sophisticated integrated communication platform. Next-generation (NG) wireless communication systems, including 5^{th} generation (5G) and sixth generation (6G) or new radio (NR) systems, are to provide access to information and sharing of data by various user equipment (UEs) and applications. NR is to be a unified network/system that is to meet vastly different and sometimes conflicting performance dimensions and services driven by different services and applications. As such, the complexity of such communication systems, as well as interactions between elements within a communication system, has increased. In particular, significant security challenges related to authentication and authorization mechanisms continue to exist. Token-based security frameworks are commonly employed to manage access control between network functions, but these systems can be vulnerable to various attack vectors.

### BRIEF DESCRIPTION OF THE DRAWINGS

The present disclosure is illustrated by way of example and not limitation in the figures of the accompanying drawings, in which like references indicate similar elements and in which:

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 is a network diagram illustrating a functional view of a 5G core network token verification system, according to some examples.

FIG. 4 is a data structure diagram illustrating an enhanced access token format for mitigating token reuse attacks in 5G core networks, according to some examples.

FIG. 5 is a flowchart illustrating a method for secure token verification in telecommunications networks, according to some examples, of preventing token reuse attacks in 5G core networks.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in or substituted for, those of other embodiments. Embodiments outlined in the claims encompass all available equivalents of those claims.

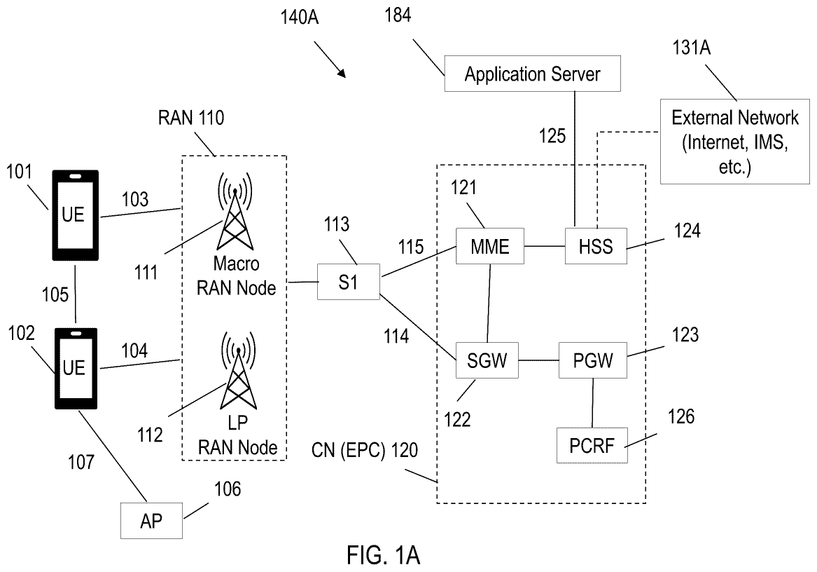

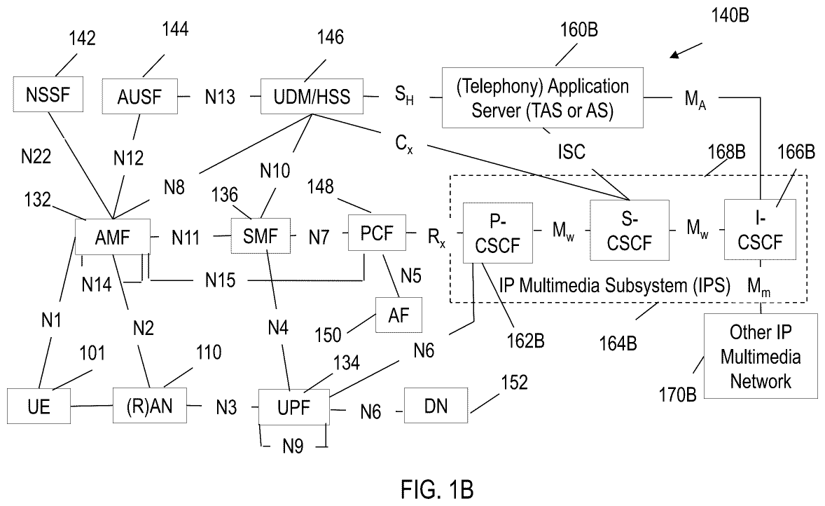

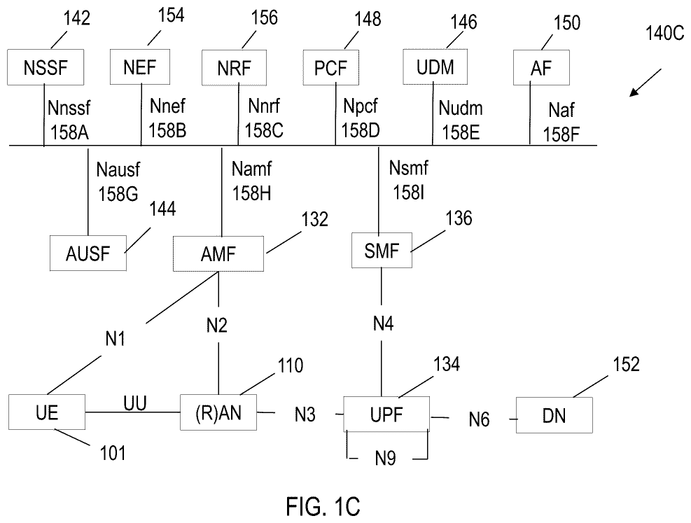

FIG. 1A illustrates an architecture of a network in accordance with some aspects. The network 140A includes 3GPP LTE/4G and NG network functions that may be extended to 6G functions. Accordingly, although 5G will be referred to, it is to be understood that this is to extend as able to 6G structures, systems, and functions. A network function may be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 may be collectively referred to herein as UE 101, and UE 101 may be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHZ, and other frequencies and Spectrum Access System (SAS) in 3.55-3.7 GHZ and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and may be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) may be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 may be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and may be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 may be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A may be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs. The CN 120 (e.g., a 5G core network/5GC) can include an access and mobility function (AMF) and/or a user plane function (UPF). The AMF and the UPF may be communicatively coupled to the gNBs and the NG-eNBs via NG interfaces. More specifically, in some aspects, the gNBs and the NG-eNBs may be connected to the AMF by NG-C interfaces, and to the UPF by NG-U interfaces. The gNBs and the NG-eNBs may be coupled to each other via Xn interfaces.

In some aspects, the NG system architecture can use reference points between various nodes. In some aspects, each of the gNBs and the NG-eNBs may be implemented as a base station, a mobile edge server, a small cell, a home eNB, and so forth. In some aspects, a gNB may be a master node (MN) and NG-eNB may be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 may be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 may be used to manage access control and mobility and can also include network slice selection functionality. The AMF 132 may provide UE-based authentication, authorization, mobility management, etc., and may be independent of the access technologies. The SMF 136 may be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 may be deployed in one or more configurations according to the desired service type and may be connected with a data network. The PCF 148 may be configured to provide a policy framework using network slicing, mobility management, and roaming (similar to PCRF in a 4G communication system). The UDM may be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B may be configured to be the first contact point for the UE 102 within the IM subsystem (IMS) 168B. The S-CSCF 164B may be configured to handle the session states in the network, and the E-CSCF may be configured to handle certain aspects of emergency sessions such as routing an emergency request to the correct emergency center or PSAP. The I-CSCF 166B may be configured to function as the contact point within an operator's network for all IMS connections destined to a subscriber of that network operator, or a roaming subscriber currently located within that network operator's service area. In some aspects, the I-CSCF 166B may be connected to another IP multimedia network 170B, e.g., an IMS operated by a different network operator.

In some aspects, the UDM/HSS 146 may be coupled to an application server 184, which can include a telephony application server (TAS) or another application server (AS) 160B. The AS 160B may be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures may be service-based and interaction between network functions may be represented by corresponding point-to-point reference points Ni or as service-based interfaces.

In some aspects, as illustrated in FIG. 1C, service-based representations may be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein may be used for supporting high reliability in distributed communication systems with dynamic topologies, including sidelink NR V2X communication systems.

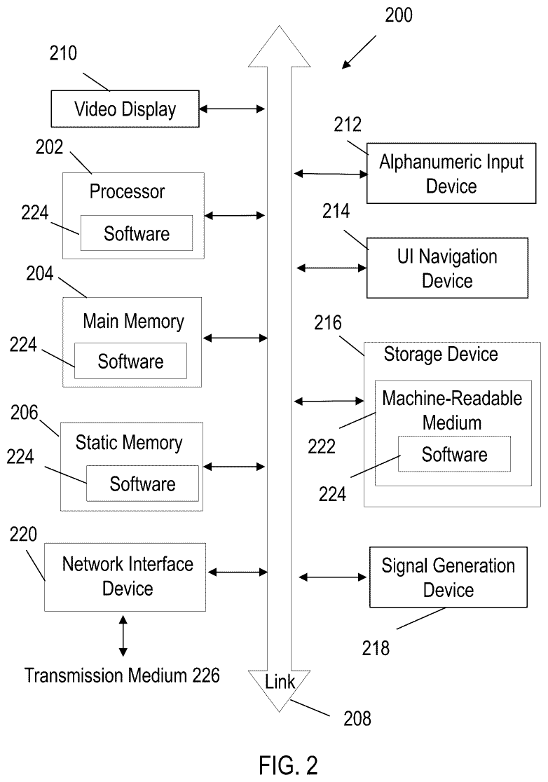

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or another sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The non-transitory machine readable medium 222 is a tangible medium. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5^{th} generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single-or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3 GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as 3GPP Generic Access Network, or GAN standard), Zigbee, Bluetooth(r), Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHz), ITS-G5B (i.e., Operation in European ITS frequency bands dedicated to ITS non-safety applications in the frequency range 5,855 GHz to 5,875 GHZ), ITS-G5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Aspects described herein may be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHZ, 3.6-3.8 GHz and further frequencies and SAS=Spectrum Access System/CBRS=Citizen Broadband Radio System in 3.55-3.7 GHZ and further frequencies). Applicable spectrum bands include IMT (International Mobile Telecommunications) spectrum as well as other types of spectrum/bands, such as bands with national allocation (including 450-470 MHZ, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 MHz, 2300-2400 MHZ, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHZ, 3400-3800 MHZ, 3800-4200 MHz, 3.55-3.7 GHZ (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHZ (note: allocated for example in South Korea, 5925-7125 MHz and 5925-6425 MHz band (note: under consideration in US and EU, respectively. Next generation Wi-Fi system is expected to include the 6 GHz spectrum as operating band, but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHZ, 3800-4200 MHz, 3.5 GHZ bands, 700 MHz bands, bands within the 24.25-86 GHz range, etc.), spectrum made available under FCC's “Spectrum Frontier” 5G initiative (including 27.5-28.35 GHz, 29.1-29.25 GHZ, 31-31.3 GHZ, 37-38.6 GHz, 38.6-40 GHz, 42-42.5 GHz, 57-64 GHz, 71-76 GHz, 81-86 GHz and 92-94 GHZ, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHZ) and WiGig Band 3 (61.56-63.72 GHz) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme may be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

As above, token-based security frameworks used to manage access control between network functions (NFs) remain vulnerable to various attack vectors. NFs interact through service-based interfaces, which use robust security protocols to ensure that only authorized entities can access specific services. The complexity of modern telecommunications architectures, with their distributed nature and multiple network slices, creates potential security gaps in token validation processes. For example, network slicing, which allows multiple virtual networks to operate on shared physical infrastructure, introduces additional authentication challenges as different NFs may serve different slices with varying security requirements. Token management in telecommunications networks involves multiple components including token issuance, verification, and revocation. Without proper security measures, tokens intended for specific services or network functions may be misappropriated or reused in unintended contexts. Accordingly, the verification of token attributes and claims is used for telecommunications security architecture.

The described examples focus on three specific vulnerabilities in 5G core networks. The first vulnerability involves token reuse attacks where a compromised NF Service Consumer obtains an access token for a specific NF Service Producer but misuses the access token to access services from a different NF Service Producer of the same type. This occurs when a malicious consumer redirects the token to an unauthorized producer, bypassing intended security controls.

The second vulnerability emerges when an NF Service Producer updates its authorization attributes to revoke a consumer's access, but the consumer continues using a previously issued access token until the access token expires. Current systems lack mechanisms to determine whether an access token was created before or after access revocation, creating a security gap.

The third vulnerability involves NF discovery bypass attacks where a malicious consumer manipulates attributes in NFDiscoveryRequests to discover NF profiles that should be restricted, potentially exposing sensitive metadata.

To address these vulnerabilities, various solutions may be implemented. For the first vulnerability, the Network Repository Function (NRF) includes additional claims in the access token. These claims include the NFInstanceID and NFSetID of authorized producer NF instances when the request is for a specific NF Type. Additionally, a “producerSnssaiList” attribute lists all Single Network Slice Selection Assistance Information (S-NSSAIs) that the NF Service Consumer is authorized to access.

When an NF Service Consumer requests an access token from the NRF, the NRF verifies that the input parameters match with the corresponding parameters in the public key certificate or NF profile of the NF Service Consumer. The NRF then generates an access token with appropriate claims, including the NF Instance ID of the NRF, NF Instance ID of the NF Service Consumer, NF type of the NF Service Producer, expected service names, expiration time, and the NFInstanceID and NFSetID of authorized producer NF instances.

For the second vulnerability, a ‘token issuance timestamp’ is introduced in the access token claims, indicating the exact time the token was issued. This timestamp allows NF Service Producers to compare the ‘token issuance timestamp’ against a ‘last authorization update timestamp’ recorded during the most recent update to the NF/NFService profiles. Access is granted only if the token's issuance timestamp is later than or equal to the last authorization update timestamp.

An alternative solution for this vulnerability implements a Token Revocation List (TRL) maintained by the NRF. When an NF Service Producer updates its authorization attributes and invokes the NFUpdate API call to revoke the access of an NF Service Consumer, the NRF marks existing access tokens associated with the NF Service Consumer as revoked in the TRL. NF Service Producers query the list to verify the revocation status of tokens before granting service access.

For the third vulnerability, the NFDiscoveryRequest verification process is enhanced. Upon receiving an NFDiscoveryRequest, the NRF cross-verifies the requesterSnssais attribute with the sNssais attribute in the NFProfile of the requesting NF Service Consumer. This ensures the requesting NF is authorized to discover target NFs based on the service capabilities and permissions of the requesting NF. The NRF then validates the requested sNssais against the allowed Snssais attribute in the NFProfile of target NFs. Only NFs whose allowed Snssais match the requested sNssais are considered valid targets for discovery. This cross-verification prevents malicious consumers from manipulating attributes to bypass restrictions.

The service request process involves two main steps: requesting an access token by the NF Service Consumer and verification of the access token by the NF Service Producer. During token verification, the NF Service Producer ensures the integrity of the access token by verifying the signature using the public key of the NRF or checking the MAC value using a shared secret. The NF Service Producer also verifies various claims in the token, including the subject claim, audience claim, scope, and expiration time.

With the enhanced verification process, the NF Service Producer additionally checks that its NFInstanceID matches one of the authorized NFInstanceIDs in the access token and that the issuance timestamp of the access token is not older than the last authorization update timestamp. If the verification is successful, the NF Service Producer executes the requested service. Otherwise, the NF Service Producer replies with an OAuth 2.0 error response.

Comprehensive logging and monitoring mechanisms are also implemented. All NFDiscoveryRequests and outcomes thereof are logged by the NRF, with anomalies or patterns indicative of potential bypass attempts triggering alerts for further investigation.

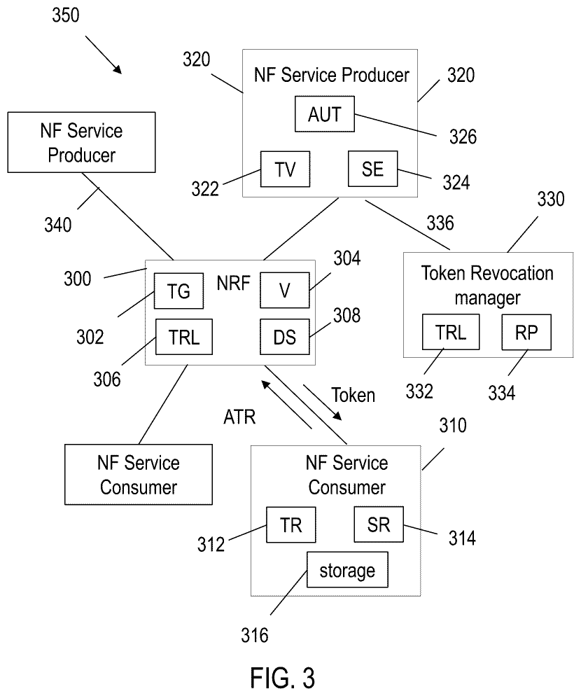

FIG. 3 is a network diagram showing a functional view of a 5G core network token verification system, according to some examples. The network 350 illustrates a NRF 300 that serves as the central authorization server within the 5G core network. The NRF 300 connects to one or more NF Service Consumers 310 and one or more NF Service Producers 320 through secure communication channels 340.

The NF Service Consumer 310 may be implemented as an AMF that requests services from other network functions. The NF Service Consumer 310 includes a token requester 312 that formulates access token requests to the NRF 300, a service requester 314 that uses the obtained token to request services from NF Service Producers 320, and a secure storage 316 that stores received tokens. The access token requests formed by the token requester 312 have appropriate parameters including NF Instance ID, requested scope, and optionally S-NSSAIs or NSI IDs. The service requester 314 attaches the access token to service requests directed to the NF Service Producers 320.

The NRF 300 comprises a token generator 302 that creates access tokens with enhanced security claims, a verification engine 304 that validates token requests against NF profiles, and a Token Revocation List (TRL) 306 that maintains records of revoked tokens. The NRF 300 may also include a discovery server 308 that processes NFDiscoveryRequests and performs cross-verification of attributes. The token generator 302, verification engine 304, TRL 306, and discovery server 308 interconnect through internal communication buses that facilitate secure data exchange between the components.

In particular, the token generator 302 creates access tokens with enhanced security claims including NFInstanceID, NFSetID, and a mandatory producerSnssaiList attribute. The token generator 302 incorporates a cryptographic signing unit that digitally signs generated tokens using either a private key for asymmetric encryption or a shared secret for MAC-based verification. In some examples, the token generator 302 also embeds a token issuance timestamp that indicates the time when the token was created.

The verification engine 304 validates token requests against stored NF profiles in a NF profile database. The verification engine 304 performs multi-factor verification including parameter matching between the request and the public key certificate or NF profile of the requesting NF Service Consumer 310. The verification engine 304 also contains an S-NSSAI validator that verifies slice-specific authorization parameters.

The discovery server 308 handles NFDiscoveryRequests and implements enhanced verification mechanisms. The discovery service processor 208 contains a cross-verification module that validates the requesterSnssais attribute against the sNssais attribute in the NFProfile of the requesting NF Service Consumer. The discovery server 308 also includes an anomaly detector that identifies and logs potential bypass attempts.

A token revocation manager 330 maintains a TRL 332 that records identifiers of all revoked tokens. The token revocation manager 330 includes a revocation processor 334 that marks existing access tokens as revoked when an NF Service Producer updates its authorization attributes through the NFUpdate API. The TRL 332 interfaces with external NF Service Producers through a secure query interface 336 that allows producers to verify token revocation status in real-time. The token revocation manager 330 may be disposed in the NRF 300.

The NF Service Producer 320 may be implemented as a User Data Management (UDM) function that provides services to other network functions. The NF Service Producer 320 includes a token verifier 322 that validates incoming tokens by checking NFInstanceID, NFSetID, S-NSSAI authorization, and token issuance timestamp against the last authorization update timestamp. The token verifier 322 thus performs comprehensive token validation including signature verification, claim validation, and timestamp comparison. The NF Service Producer 320 also contains a service executor 324 that processes authorized service requests. The NF Service Producer 320 also contains an authorization update tracker 326 that maintains a last authorization update timestamp that serves as a reference point for validating token issuance timestamps.

The NF Service Producers 320 may have the same type but serve different network slices, as identified by their S-NSSAIs. The enhanced token verification mechanisms prevent a compromised NF Service Consumer 310 from using a token intended for one NF Service Producer 320 to access services from another unauthorized NF Service Producer 320.

In operation, the NF Service Consumer 310 sends an access token request to the NRF 300 through communication channel 340. The NRF 300 verifies the request parameters against a profile of the NF Service Consumer 310 and generates an access token with appropriate claims, including NFInstanceID, NFSetID, and producerSnssaiList. The NRF 300 then sends the token back to the NF Service Consumer 310.

The NF Service Consumer 310 subsequently uses this token to request services from the NF Service Producer 320. The NF Service Producer 320 verifies the integrity and claims of the token, including checking that the NFInstanceID of the NF Service Producer 320 matches one of the authorized NFInstanceIDs in the token. The NF Service Producer 320 may also query the TRL 306 in the NRF 300 to ensure the token has not been revoked.

The network 350 implements secure communication channels 340 between all components using TLS-based encryption. The secure communication channels 340 facilitate the exchange of token requests, access tokens, service requests, and verification queries. In some examples, the secure communication channels 340 may implement additional security measures such as mutual authentication and certificate validation.

The system architecture supports alternative token revocation mechanisms. In addition to the TRL-based approach, the network 350 may implement a timestamp-based verification in which the NF Service Producer 320 compares the issuance timestamp of the token against the last authorization update timestamp recorded during profile updates. Access is granted only if the issuance timestamp of the token is later than or equal to the last authorization update timestamp.

For NFDiscovery security, the system implements a validation pipeline that processes discovery requests through multiple verification stages. The pipeline includes components for authenticating the requesting NF, validating S-NSSAI parameters, and authorizing discovery based on cross-verification results. The system logs all discovery requests and verification outcomes in a secure audit log that supports forensic analysis and security monitoring.

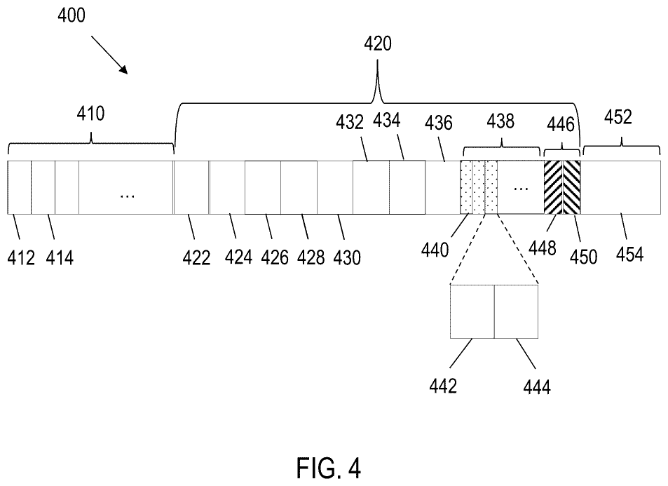

FIG. 4 is a data structure diagram illustrating the enhanced access token format for mitigating token reuse attacks in 5G core networks, according to some examples. The diagram depicts an Access Token structure 400 containing multiple claim fields that collectively enhance security verification. The Token Header 410 includes JSON Web Token (JWT) fields such as algorithm type 412 and token type 414. The algorithm type 412 specifies the cryptographic algorithm used for token signing, while the token type 414 identifies the token format as JWT.

The Token Payload 420 contains substantive claims that enable enhanced verification. An issuer claim 422 stores the NF Instance ID of the NRF that generated the token. A subject claim 424 contains the NF Instance ID of the NF Service Consumer requesting access. An audience claim 426 specifies the NF type of the NF Service Producer for which the token is intended. A scope claim 428 lists the expected service names that the consumer is authorized to access. An expiration claim 430 indicates the time after which the token becomes invalid. The token issuance timestamp 432 records the exact time when the token was issued, enabling comparison against the last authorization update timestamp during verification. An authorizedNFInstances claim 434 contains an array of NFInstanceIDs representing the specific producer NF instances that the consumer is authorized to access. The authorizedNFInstances claim 434 serves as a primary security enhancement by explicitly binding the token to authorized producer instances. A NFSetID claim 436, when applicable, identifies the set of NF instances that may process the token. A producerSnssaiList claim 438 contains an array of S-NSSAI values 440 representing all network slices that the consumer NF is authorized to access. Each S-NSSAI value 440 includes a Slice/Service Type (SST) 442 and a Slice Differentiator (SD) 444, forming a one-to-many relationship between the token and authorized network slices.

Additional scope information 446 may include allowed resources 448 and allowed actions 450 that further restrict the usage of the token to specific service operations. This forms a one-to-many relationship between the token and the operations it authorizes.

A token signature 452 contains a cryptographic signature 454 generated using either the private key of the NRF or a shared secret, depending on the algorithm specified in the header 410. The signature 452 establishes a one-to-one relationship with the token payload 420, ensuring the integrity of the token payload 420 during verification.

The data structure supports the token verification process by providing the desired information for the NF Service Producer to validate the authenticity and authorization scope of the token. During verification, the NF Service Producer extracts the claims from the token and compares the claims against the identity attributes of the NF Service Producer, including its NFInstanceID, NFSetID, and S-NSSAIs.

In some examples, the data structure may include additional fields such as a token identifier that uniquely identifies the token for revocation purposes. The token identifier forms a one-to-one relationship with entries in the TRL maintained by the NRF, enabling efficient token revocation checks.

The data structure integrates with the token generation module in the NRF and the token verification module in the NF Service Producer. The NRF populates the fields during token creation based on the request parameters and authorization policies of the NF Service Consumer. The NF Service Producer extracts and validates the fields during service request processing to prevent token reuse attacks across unauthorized NF instances.

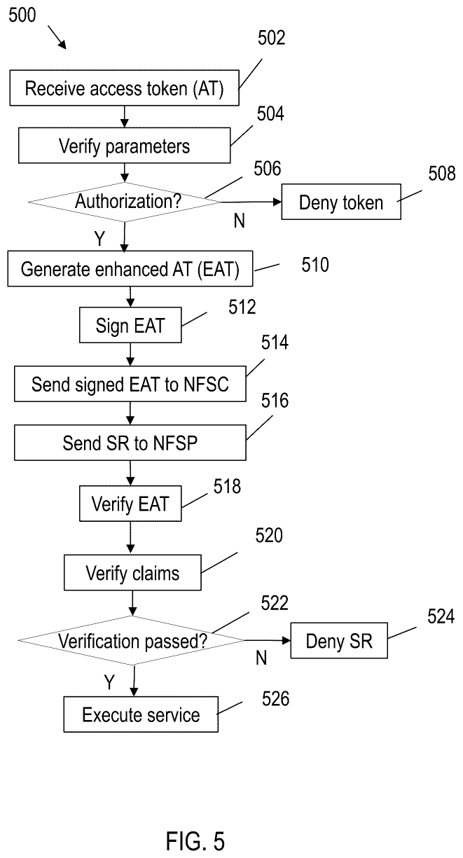

FIG. 5 is a flowchart illustrating a method for secure token verification in telecommunications networks, according to some examples, of preventing token reuse attacks in 5G core networks. Although the example method 500 depicts a particular sequence of operations, the sequence may be different from that shown. For example, some of the operations depicted may not be performed, some may be performed in parallel or in a different sequence that does not materially affect the function of the method, and additional operations may be present that are not shown. In some examples, different components of an example device or system that implements the method may perform functions at substantially the same time or in a specific sequence.

At operation 502, a NRF receives an access token request from an NF Service Consumer. The request includes the NF Instance ID of the NF Service Consumer, the requested scope (including expected NF Service names), and the NF type of the expected NF Service Producer instance. The request may also include a list of S-NSSAIs or NSI IDs for the expected NF Service Producer instances, as well as the NF Set ID and/or NF Service Set ID of the expected NF Service Producer instances.

At operation 504, the NRF verifies the input parameters in the access token request. The verification process includes checking that the NF Instance ID and NF type, as well as PLMN ID(s) if available, match with the corresponding ones in the public key certificate of the NF Service Consumer or those in the NF profile of the NF Service Consumer. The NRF may additionally verify the S-NSSAIs of the NF Service Consumer and check for restrictions on accessing NF Service Producers' services based on slice information.

At operation 506, the NRF determines whether the NF Service Consumer is authorized to access the requested service. If the verification fails or if the NF Service Consumer is not authorized, the process proceeds to operation 508, where the NRF denies the token request and sends an OAuth 2.0 error response to the NF Service Consumer. If the verification succeeds and the NF Service Consumer is authorized, the process continues to operation 510.

At operation 510, the NRF generates an access token with enhanced security claims. The claims include the NF Instance ID of the NRF (issuer), NF Instance ID of the NF Service Consumer (subject), NF type of the NF Service Producer (audience), expected service names (scope), expiration time, NFInstanceID and NFSetID of authorized producer NF instances, and a token issuance timestamp. The NRF also includes a producerSnssaiList attribute that lists all S-NSSAIs the consumer NF is authorized to access.

At operation 512, the NRF digitally signs the generated access token using either a shared secret or private key as described in RFC 7515. This ensures the token's integrity during transmission and verification.

At operation 514, the NRF sends the signed access token to the NF Service Consumer in the Nnrf_AccessToken_Get response operation. The NF Service Consumer may store the received token for future use during its validity period.

At operation 516, the NF Service Consumer sends a service request to an NF Service Producer, including the access token received from the NRF. Before processing this request, the NF Service Consumer and NF Service Producer authenticate each other following the authentication procedures specified in the telecommunications network protocols.

At operation 518, the NF Service Producer verifies the token integrity by checking the signature using the NRF public key or verifying the MAC value using the shared secret. The NF Service Producer also compares the token issuance timestamp against the last authorization update timestamp recorded during the most recent update to the NF/NFService profiles.

At operation 520, the NF Service Producer verifies the claims in the token. This includes checking that the NF Instance ID in the subject claim matches the NF Instance ID in the subjectAltName in the NF Service Consumer's TLS client certificate, verifying that the audience claim matches its own identity or NF type, and confirming that its NFInstanceID is included in the list of authorized NFInstanceIDs. The NF Service Producer also checks that the token has not expired by comparing the expiration time against the current date/time.

At operation 522, the NF Service Producer determines whether all verification checks have passed. If any verification check fails, the process proceeds to operation 524, where the NF Service Producer denies the service request and sends an OAuth 2.0 error response to the NF Service Consumer. If all verification checks pass, the process continues to operation 526.

At operation 526, the NF Service Producer executes the requested service and sends the response back to the NF Service Consumer. This completes the secure token verification process that prevents token reuse attacks across unauthorized NF instances.

In some examples, the method may include additional blocks for token revocation verification. After operation 518, the NF Service Producer may query a TRL maintained by the NRF to check if the token has been revoked. If the token is found in the TRL, the NF Service Producer denies the service request regardless of other verification results.

Three different situations (CVD 1, CVD 2, CVD 3) may occur in which the above enhancements may be desirable.

CVD 1: In a partial core network setup with two UDM instances (P2 and P3), a compromised NF Service Consumer C1 (e.g., AMF) wants services from a particular NF Service Producer (e.g., UDM) registered in the NRF. Consumer NF C1 and candidate producer NF P3 are in the same slice, i.e., sNssai 1 whereas another candidate producer NF P2 is in different a network slice, i.e., sNssai 3. Before service access, C1 is to be provided with an access token from NRF. C1 invokes an access token request (which is for a specific NF Type) to the NRF (step 1). The NRF verifies that C1 has permission to access P3, and grants C1 an accessToken T containing proper scopes for P3 (step 2). However, instead of making the service request to P3, C1 uses accessToken T to request a service from P2 (step 3). P2 verifies the attributes in T and grants service access to P2 (step 3 & 4). Note that this vulnerability is generic to producers of any NFType, and is not limited to UDM. To successfully carry out the attack, C1 is malicious and uses the knowledge of victim's (P2) FDN/IP address to make the service request.

CVD2: an NF service consumer has obtained an access token for an NF service producer, and the producer now wants to revoke the consumer's access. To do this, the producer updates the authorization attributes in its NF/NFservice profiles and invokes the NFUpdate API call with the Network Repository Function (NRF). After the update, the consumer should no longer have access to the producer. However, the consumer can still access the producer's services using the previously issued access token, as long as the token has not yet expired. Previously no way existed for the service producer to determine whether the access token was created before or after a consumer's access revocation, which is a potential security vulnerability that should be addressed to ensure the integrity and confidentiality of the service provider's data.

CVD3: a malicious consumer (C1) is able to discover a producer (P1), even if the allowed Snssais attribute in P1's NFProfile clearly forbids access of C1. In NFDiscoveryRequest, the consumer may set two attributes along with others i.e., sNssais, which denotes sNssais to be discovered by the consumer, and requestersNssais, which refers to sNssais served by the consumer. During verification process, the NRF finds target NFs that serve the sNssais as in requestersNssais, and then, filters the target NFs based on sNssais attribute. However, because both of the attributes in the message are set by the consumer, the consumer (if malicious) can set these attributes to any values to discover any NF in the 5G core. In this way, a compromised consumer NF can extract the NFProfile of any NF, which includes sensitive metadata of the victim NF that may be further exploited.

As above, the complete service request is a two-step process including requesting an access token by NF Service Consumer (Step 1, i.e. 1a or 1b), and then verification of the access token by NF Service Producer (Step 2).

Step 1: Access token request

Pre-requisites:

The NF Service consumer (OAuth2.0 client) is registered with the NRF (Authorization Server).

The NF Service Producer (OAuth2.0 resource server) is registered with the NRF (Authorization Server) with optionally “additional scope” information per NF type.

The NRF and NF Service Producer share the required credentials.

The NRF and NF have mutually authenticated each other—where the NF Service Consumer is identified by the NF Instance ID of the public key certificate of the NF Service Consumer.

Step 1a. Access token request for accessing services of NF Service Producers of a specific NF type

The following procedure describes how the NF Service Consumer obtains an access token before service access to NF Service Producers of a specific NF type.

1. The NF Service Consumer requests an access token from the NRF in the same PLMN using the Nnrf_AccessToken_Get request operation. The message includes the NF Instance Id(s) of the NF Service Consumer, the requested “scope” including the expected NF Service name(s) and optionally “additional scope” information (i.e. requested resources and requested actions (service operations) on the resources), NF type of the expected NF Service Producer instance and NF Service Consumer. The NF Service Consumer may also include a list of S-NSSAIs or list of NSI IDs for the expected NF Service Producer instances. The message may include the NF Set ID and/or NF Service Set Id of the expected NF Service Producer instances.

The message may include a list of S-NSSAIs of the NF Service Consumer. The message may also include the PLMN ID(s) of the NF Service Consumer.

2. The NRF verifies that the input parameters NF Instance ID and NF type as well as PLMN ID(s), if available, in the access token request match with the corresponding ones in the public key certificate of the NF Service Consumer or those in the NF profile of the NF Service Consumer. If the verification of the parameters in the access token request fails, the access token request is not further processed or if the token's issuance timestamp predates the ‘last authorization update timestamp,’ the access token request is not processed, and the NF Service Consumer is informed that re-authentication is to take place. The NRF may additionally verify the S-NSSAIs of the NF Service Consumer and check whether there are restrictions on the NF Service Consumer to access NF Service Producers' services of a specific NF type depending on the slices for which the services are offered. The NRF checks whether the NF Service Consumer is authorized to access the requested service(s). For example, the NRF may verify that the NF Service Consumer can serve a slice which is included in the allowed slices for the NF Service Producer of a specific NF type. If the NF Service Consumer is authorized, the NRF then generates an access token with appropriate claims included. The NRF digitally signs the generated access token based on a shared secret or private key. If the NF Service Consumer is not authorized, the NRF does not issue an access token to the NF Service Consumer.

The claims in the token include the NF Instance Id of NRF (issuer), NF Instance Id of the NF Service Consumer (subject), NF type of the NF Service Producer (audience), expected service name(s) (scope), expiration time (expiration), NFInstanceID, and NFSetID (if applicable) of the authorized producer NF instances and optionally “additional scope” information (allowed resources and allowed actions (service operations) on the resources), and a ‘token issuance timestamp’ indicating the exact time the token was issued. Additionally, the ‘producerSnssaiList’ attribute, listing all S-NSSAIs that the consumer NF is authorized to access, is included in the access token when the request is for a specific NF Type. This ensures precise authorization and prevents misuse of the access token across unauthorized instances of the same NFType. The claims may include a list of S-NSSAIs or NSI IDs for the expected NF Service Producer instances. The claims may include the NF Set ID and/or NF Service Set Id of the expected NF Service Producer instances. If the claims do not include a list of NSSAIs or NSI IDs for the target NF type, this implies the token can be used to access expected NF services of all expected NF Service Producers of the NF type based on local configuration and operator policy.

3. If the authorization is successful, the NRF sends an access token to the NF Service Consumer in the Nnrf_AccessToken_Get response operation. Otherwise the NRF replies based on an Oauth 2.0 error response. Other parameters (e.g., the expiration time, allowed scope) sent by NRF in addition to the access token are described in 3GPP TS 29.510.

The NF Service Consumer may store the received token(s). Stored tokens may be re-used for accessing service(s) from NF Service Producer NF type listed in claims (scope, audience) during their validity time.

1b. Access token request for accessing services of a specific NF Service Producer instance/NF Service Producer service instance.

The following steps describes how the NF Service Consumer obtains an access token before service access to a specific NF Service Producer instance/NF Service Producer service instance.

1. The NF Service Consumer requests an access token from the NRF for a specific NF Service Producer instance/NF Service Producer service instance. The request includes the NF Instance Id(s) of the requested NF Service Producer, the expected NF Service name, optionally “additional scope” information (allowed resources and allowed actions (service operations) on the resources) and NF Instance Id of the NF Service Consumer. The request may also include the PLMN ID(s) of the NF Service Consumer.

2. The NRF verifies that the input parameters in the access token request, i.e., NF Instance ID and, if available, PLMN ID(s) and NF type, match with the corresponding ones in the public key certificate of the NF Service Consumer or those in the NF profile of the NF Service Consumer. If the verification of the parameters in the access token request fails or if the token's issuance timestamp predates the ‘last authorization update timestamp,’ the access token request is not processed, and the NF Service Consumer shall be informed of the need to re-authenticate.

The NRF checks whether the NF Service Consumer is authorized to access the requested services from the NF Service Producer instance/NF Service Producer service instance, and then proceeds to generate an access token with the appropriate claims included. If the NF Service Consumer is not authorized, the NRF does not issue an access token to the NF Service Consumer.

The claims in the token include the NF Instance Id of NRF (issuer), NF Instance Id of the NF Service Consumer (subject), NF Instance Id or several NF Instance Id(s) of the requested NF Service Producer (audience), expected service name(s) (scope), optionally “additional scope” information (allowed resources and allowed actions (service operations) on the resources), and expiration time (expiration), and a ‘token issuance timestamp’ indicating the exact time the token was issued.

Adding a ‘token issuance timestamp’ to the token's claims allows NF Service Producers to determine the token's issuance relative to any changes in access rights, enabling them to reject requests based on outdated tokens.

3. The token is included in the Nnrf_AccessToken_Get response sent to the NF Service Consumer. The NF Service Consumer may store the received token(s). Stored tokens may be re-used for accessing service(s) from NF Instance Id or several NF Instance Id(s) of the requested NF Service Producer instance listed in claims (scope, audience) during their validity time.

Step 2: Service access request based on token verification

The following procedure describe how authorization is performed during Service request of the NF Service Consumer. Prior to the request, the NF Service Consumer may perform Nnrf_NFDiscovery_Request operation with the requested additional scopes to select a suitable NF Service Producer (resource server) which is able to authorize the Service Access request.

Pre-requisite: The NF Service Consumer is in possession of a valid access token before requesting service access from the NF Service Producer.

1. The NF Service Consumer requests service from the NF Service Producer. The NF Service Consumer includes the access token. The NF Service Consumer and NF Service Producer authenticate each other.

2. The NF Service Producer verifies the token as follows:

The NF Service Producer ensures the integrity of the token by verifying the signature using NRF's public key or checking the MAC value using the shared secret. Additionally, the NF Service Producer compares the ‘token issuance timestamp’ against the ‘last authorization update timestamp’ recorded at the time of the most recent update to the NF/NFService profiles. Access is granted only if the token's issuance timestamp is later than or equal to the ‘last authorization update timestamp. This ensures that NF Service Producers can effectively determine whether a token was issued before or after the latest authorization update, preventing unauthorized access using outdated tokens.

If the integrity check is successful, the NF Service Producer verifies the claims in the token as follows:

In the direct communication case, the NF Service Producer checks that the NF Instance ID in the subject claim within the access token matches the NF Instance ID in the subjectAltName in the NF Service Consumer's TLS client certificate.

The NF Service Producer checks that the audience claim in the access token matches its own identity or the type of NF Service Producer. If a list of S-NSSAIs or list of NSI IDs is present, the NF Service Producer checks that the NF Service Producer serves the corresponding slice(s). If applicable (e.g., when the request is for information related to a specific UE), the NF Service Producer may check that the NF Service Consumer is allowed to access (as indicated by the NF Service Producer's S-NSSAIs in the access token presented by the NF Service Consumer) at least one of the slice(s) that the UE is currently registered to, e.g., by verifying that the UE's allowed NSSAI(s) intersect with the NF Service Producer's S-NSSAIs in the access token.

If an NF Set ID present, the NF Service Producer checks the NF Set ID in the claim matches its own NF Set ID.

If an NF Service Set ID present, the NF Service Producer checks if the NF Service Consumer is authorized to access the requested service according to the NF Service Producer Service Set ID in the access token claim.

If scope is present, the NF Service Producer checks that the scope matches the requested service operation.

If the access token contains “additional scope” information (i.e., allowed resources and allowed actions (service operations) on the resources), the NF Service Producer checks that the additional scope matches the requested service operation.

The NF Service Producer checks that the access token has not expired by verifying the expiration time in the access token against the current data/time.

If the CCA is present in the service request, the NF Service Producer may verify the CCA=and that the subject claim (i.e., the NF Instance Id of the NF Service Consumer) in the access token matches the subject claim in the CCA.

3. If the verification is successful, the NF Service Producer executes the requested service and responds back to the NF Service Consumer. Otherwise, the NF Service Producer replies based on the Oauth 2.0 error response.

Alternatively for CVD2, to address the potential security vulnerability where an NF service consumer can still access the producer's services using a previously issued access token after their access has been revoked, the following process may be implemented:

Token Revocation Notification: when an NF service producer updates its authorization attributes and invokes the NFUpdate API call with the NRF to revoke a consumer's access, the NRF marks any existing access tokens associated with the consumer for the specific service as revoked.

The NRF maintains a TRL that records the identifiers of all revoked tokens. This list is accessible by all NF service producers to verify the revocation status of a token.

Upon receiving a service request with an access token, the NF service producer queries the TRL to verify if the token has been revoked. This check is performed in addition to the existing verification steps outlined in Step 2 of the service request process.

If the access token is found in the TRL, indicating that the access token has been revoked, the NF service producer denies the service request and respond with an appropriate error message indicating that the token is no longer valid.

The NRF provides a mechanism for NF service producers to periodically update their local copy of the TRL or query the TRL in real-time to ensure they have the most current revocation information.

For CVD3: to mitigate the NFDiscovery bypass attack, the following verification process may be implemented:

Cross-Verification of RequesterSnssais and sNssais: Upon receiving an NFDiscoveryRequest, the NRF cross-verifies the requesterSnssais attribute in the NFDiscoveryRequest message with the sNssais attribute in the NFProfile of the requesting NF (NF Service Consumer). This ensures that the requesting NF is authorized to discover the target NFs based on its own service capabilities and permissions.

Validation Against AllowedSnssais: The NRF then proceeds to validate the sNssais requested for discovery against the allowedSnssais attribute in the NFProfile of the target NFs. Only those NFs whose allowedSnssais match the requested sNssais are considered valid targets for discovery.

Enhanced Authentication and Authorization: Prior to executing the NFDiscoveryRequest, the NRF authenticates the NF Service Consumer and authorize the discovery request based on the enhanced verification process outlined above. This includes ensuring that the NF Service Consumer is not attempting to bypass restrictions by forging or manipulating the requesterSnssais or sNssais attributes.

Logging and Monitoring: All NFDiscoveryRequests and their outcomes are logged by the NRF. Anomalies or patterns indicative of potential bypass attempts trigger alerts for further investigation and perhaps modification of access by the problematic party.

Accordingly, examples of secure token verification in telecommunications networks seek to provide technical solutions to a number of example technical problems, including the following:

1. Token Reuse Across Unauthorized NF Instances in which a compromised NF Service consumer can obtain an access token for a specific NF Service producer but misuse the access token to access services from a different NF Service producer of the same type. This vulnerability occurs when a malicious consumer redirects the token to an unauthorized producer, bypassing intended security controls.

The described technology addresses this problem by enhancing the token structure with additional binding parameters that explicitly tie the token to authorized producer NF instances:

The NRF includes NFInstanceID and NFSetID in the access token when the request is for a specific NF Type. This creates a binding between the token and the specific authorized NF instances.

A “producerSnssaiList” attribute is included in the access token, listing all S-NSSAIs (Single Network Slice Selection Assistance Information) that the consumer NF is authorized to access. This provides an additional layer of validation at the producer NF.

During token verification, the NF Service Producer checks that the NFInstanceID of the NF Service Producer matches one of the authorized NFInstanceIDs in the token. If there is no match, the service request is rejected regardless of other valid token parameters.

The token verifier in the NF Service Producer contains specialized verification components for checking NFInstanceID, NFSetID, and S-NSSAI authorization, ensuring comprehensive validation of all binding parameters.

This prevents token reuse attacks by ensuring that even if a token is valid for a particular NF type, the token cannot be used to access services from unauthorized instances of that same NF type.

2. Continued Access After Authorization Revocation, in which when an NF service producer updates its authorization attributes to revoke a consumer's access, the consumer can still access the producer's services using a previously issued access token until the token expires. Current systems lack mechanisms to determine whether an access token was created before or after access revocation, creating a security gap.

Complementary approaches may be used to address this problem: Timestamp-Based Verification and TRL. In Timestamp-Based Verification, a ‘token issuance timestamp’ is included in the access token claims, indicating the exact time the token was issued. The NF Service Producer maintains a ‘last authorization update timestamp’ recorded during the most recent update to the NF/NFService profiles of the NF Service Producer. During token verification, the NF Service Producer compares the token's issuance timestamp against the last authorization update timestamp. Access is granted only if the token's issuance timestamp is later than or equal to the last authorization update timestamp. The authorization update tracker in the NF Service Producer maintains this timestamp and facilitates the comparison during verification.

Alternatively, or in addition, the NRF maintains a Token Revocation List (TRL) that records identifiers of all revoked tokens. When an NF service producer updates its authorization attributes and invokes the NFUpdate API call to revoke a consumer's access, the NRF marks existing access tokens associated with that consumer as revoked in the TRL. The token revocation manager includes a revocation processor that handles this marking process. During token verification, the NF Service Producer queries the TRL through a secure query interface to verify if the token has been revoked before granting access. The system supports periodic updates of local TRL copies or real-time queries to ensure NF Service Producers have current revocation information.

This ensures that revoked access rights take effect immediately, regardless of token expiration times, closing the security gap in the authorization system.

3. NFDiscovery Bypass Attacks, in which a malicious NF Service Consumers can manipulate attributes in NFDiscoveryRequests to discover NF profiles that should be restricted, potentially exposing sensitive metadata. This occurs because both the sNssais and requesterSnssais attributes in the discovery request are set by the consumer and not properly verified against the consumer's actual capabilities.

To overcome this, the NFDiscoveryRequest verification process can be enhanced with multiple layers of validation. Upon receiving an NFDiscoveryRequest, the NRF cross-verifies the requesterSnssais attribute with the sNssais attribute in the NFProfile of the requesting NF Service Consumer. This ensures the requesting NF is authorized to discover target NFs based on its own service capabilities and permissions. The discovery service processor in the NRF contains a cross-verifier specifically designed to perform this validation. The NRF then validates the requested sNssais against the allowedSnssais attribute in the NFProfile of target NFs. Only NFs whose allowedSnssais match the requested sNssais are considered valid targets for discovery. A validation pipeline processes discovery requests through multiple verification stages, including components for authenticating the requesting NF, validating S-NSSAI parameters, and authorizing discovery based on cross-verification results. An anomaly detector identifies and logs potential bypass attempts, with all discovery requests and verification outcomes recorded in a secure audit log that supports forensic analysis and security monitoring. This verification process prevents malicious consumers from manipulating discovery attributes to bypass restrictions, protecting sensitive NF metadata from unauthorized exposure.

4. Lack of Comprehensive Token Verification Mechanisms, in which the lack comprehensive validation of all security-relevant attributes create potential vulnerabilities in the service access control system.

To overcome this, a multi-layered token verification approach is implemented, in which the token verifier in the NF Service Producer performs comprehensive token validation including signature verification, claim validation, and timestamp comparison. During verification, the NF Service Producer ensures the integrity of the token by verifying the signature using NRF's public key or checking the MAC value using the shared secret. The NF Service Producer verifies multiple claims in the token, including: checking that the NF Instance ID in the subject claim matches the NF Instance ID in the subjectAltName in the NF Service Consumer's TLS client certificate; verifying that the audience claim matches its own identity or NF type; checking that any S-NSSAIs or NSI IDs present match its own service capabilities; verifying that its NFInstanceID is included in the list of authorized NFInstanceIDs; checking that the scope matches the requested service operation; and verifying that the token has not expired. The enhanced Access Token structure contains multiple claim fields that collectively enable this comprehensive verification, including the token issuance timestamp, authorizedNFInstances claim, NFSetID claim, and producerSnssaiList claim.

### EXAMPLES

Example 1 is an apparatus of a Network Repository Function (NRF), the apparatus comprising a memory configured to store access tokens and a processor, the processor to configure the NRF to: receive an access token request from a Network Function (NF) Service Consumer for accessing services of an NF Service Producer; in response to reception of the access token request, verify authorization of the NF Service Consumer to access the services; in response to verification of authorization of the NF Service Consumer to access the services, generate an access token including Examples, the claims comprising claims indicative of at least: (i) an identifier of the NRF as an issuer; (ii) an identifier of the NF Service Consumer as a subject; (iii) an identifier of at least one of a target NF type or instance as an audience; (iv) an expected service name as a scope; (v) an expiration time; (vi) an identifier of an individual or grouped Network Function or slice identifier; and (vii) a token issuance timestamp indicating a time the access token was issued; digitally sign the access token; and transmit the access token to the NF Service Consumer.

In Example 2, the subject matter of Example 1 includes, wherein the claims further comprise claims indicative at least one of an NFSetID as an identifier of a set of authorized producer NF instances or a slice-identifier list identifying a network slice that the NF Service Consumer is authorized to access.

In Example 3, the subject matter of Examples 1-2 includes, wherein the processor configures the NRF to verify that input parameters in the access token request match with corresponding parameters in a public key certificate of the NF Service Consumer or in an NF profile of the NF Service Consumer.

In Example 4, the subject matter of Examples 1-3 includes, wherein the processor configures the NRF to: verify at least one of a slice or network-segment identifier of the NF Service Consumer; and determine whether restrictions exist on the NF Service Consumer to access services of a specific NF type of a NF Service Producer dependent on slices for which the NF Service Producer offers services.

In Example 5, the subject matter of Examples 1-4 includes, wherein the processor configures the NRF to include a list of at least one of S-NSSAIs or NSI IDs for expected NF Service Producer instances in the Examples of the access token.

In Example 6, the subject matter of Examples 1-5 includes, wherein the processor configures the NRF to, during processing an NFDiscoveryRequest, cross-verify, directly or indirectly, a requesterSnssais attribute or functionally equivalent slice-identifier attribute with a Single Network Slice Selection Assistance Information (S-NSSAI) attribute in an NFProfile of the NF Service Consumer.

In Example 7, the subject matter of Example 6 includes, wherein the processor configures the NRF to validate at least one of a slice or network-segment identifier requested for discovery against an allowedSnssais attribute in an NFProfile of target NFs.

In Example 8, the subject matter of Examples 6-7 includes, wherein the processor configures the NRF to: log NFDiscoveryRequests and outcomes thereof; and trigger at least one of an alert or other automated mitigation action in response to detecting at least one of anomalies or patterns indicative of potential bypass attempts.

In Example 9, the subject matter of Examples 1-8 includes, wherein the processor configures the NRF to maintain in the memory a Token Revocation List (TRL) that records identifiers of revoked access tokens.

In Example 10, the subject matter of Example 9 includes, wherein the processor configures the NRF to: receive an NFUpdate Application Programming Interface (API) call from a particular NF Service Producer to revoke access for a particular NF Service Consume; and mark an existing access token as revoked in the TRL in response to reception of the API call.

In Example 11, the subject matter of Examples 9-10 includes, wherein the processor configures the NRF to permit NF Service Producers to periodically update local copies of the TRL in the NF Service Producers or query the TRL in the NRF in real-time to verify revocation status of an existing access token before granting service access.

In Example 12, the subject matter of Examples 1-11 includes, wherein the processor configures the NRF to: verify parameters in the access token request; determine relative timing between the token issuance timestamp and a last authorization update timestamp that indicates a time of a most recent update to at least one of the NF Service Consumer or a NFService profile of the NF Service Consumer; and in response to at least one of failure of verification of the parameters in the access token request or the token issuance timestamp predating a last authorization update timestamp, not process the access token request and indicate to the NF Service Consumer to re-authenticate.

In Example 13, the subject matter of Examples 1-12 includes, wherein the processor configures the NRF to check whether the NF Service Consumer is able to serve a slice that is included in allowed slices for the NF Service Producer of a specific NF type.

In Example 14, the subject matter of Examples 1-13 includes, wherein the processor configures the NRF to include additional scope information in the Examples that include allowed resources and allowed actions on the allowed resources.

In Example 15, the subject matter of Examples 1-14 includes, wherein the processor configures the NRF to at least one of: verify that the NF Service Consumer is authorized to access the services from the NF Service Producer before generating the access token; or notify affected NF Service Producers when tokens associated with services of the affected NF Service Producers are revoked.

In Example 16, the subject matter of Examples 1-15 includes, wherein the processor configures the NRF to: authenticate the NF Service Consumer; authorize a discovery request in response to a determination that the NF Service Consumer is not attempting to bypass restrictions by forging or manipulating requesterSnssais or S-NSSAI attributes; and in response to a determination that the NF Service Consumer is not authorized, not issue the access token to the NF Service Consumer and send a reply based on OAuth 2.0 error response.

Example 17 is an apparatus of a Network Repository Function (NRF), the apparatus comprising a memory configured to store access tokens and a processor, the processor to configure the NRF to: receive, from a Network Function (NF) Service Consumer, an access token request for accessing services of an NF Service Producer for a specific Network Function Type (NFType), the access token request including NFInstanceID that is an identifier for a NF and NFSetID that is an identifier of a set of NFs; and generate, in an access token, an authorizedNFInstances field that lists NFInstanceIDs of producer NFs authorized for access by a requesting NF Service Consumer to permit an NF Service Producer to verify the authorizedNFInstances field in the access token to ensure the NFInstanceID of a service request matches one of the NFInstanceIDs in the access token and reject the service request in response to a determination that the NFInstanceID of the NF Service Producer does not match any of the NFInstanceIDs in the authorizedNFInstances field.

In Example 18, the subject matter of Example 17 includes, wherein the access token further includes an authorizedNFSetID field in response to the access token request pertaining to a specific NFSet, to permit the NF Service Producer to verify an NFSetID of the NF Service Producer against the authorizedNFSetID in the access token.

Example 19 is a non-transitory computer-readable storage medium that stores instructions for execution by one or more processors of an apparatus of a Network Repository Function (NRF), the instructions, when executed, cause the NRF to: receive an NFDiscoveryRequest from a network function (NF) Service Consumer, the NFDiscoveryRequest including a requesterSnssais attribute that indicates Single Network Slice Selection Assistance Information (S-NSSAIs) served by the NF Service Consumer and an sNssais attribute that indicates S-NSSAIs to be discovered by the NF Service Consumer; cross-verify the requesterSnssais attribute with an sNssais attribute in an NFProfile of the NF Service Consumer; validate the S-NSSAIs requested for discovery against an allowedSnssais attribute in an NFProfile of a target NF, the allowedSnssais attribute that indicates which S-NSSAIs the target NF is permitted to serve or be accessed by; authorize the NFDiscoveryRequest based on cross-verification and validation to permit the NF Service Consumer to discover the target NF based on service capabilities and permissions of the NF Service Consumer; and log the NFDiscoveryRequest and outcome.

In Example 20, the subject matter of Example 19 includes, wherein the instructions, when executed, cause the NRF to trigger an alert for further investigation upon detecting anomalies or patterns indicative of potential bypass attempts.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus of a Network Repository Function (NRF), the apparatus comprising a memory configured to store access tokens and a processor, the processor to configure the NRF to:
receive an access token request from a Network Function (NF) Service Consumer for accessing services of an NF Service Producer;
in response to reception of the access token request, verify authorization of the NF Service Consumer to access the services;
in response to verification of authorization of the NF Service Consumer to access the services, generate an access token including claims, the claims comprising claims indicative of at least: (i) an identifier of the NRF as an issuer; (ii) an identifier of the NF Service Consumer as a subject; (iii) an identifier of at least one of a target NF type or instance as an audience; (iv) an expected service name as a scope; (v) an expiration time; (vi) an identifier of an individual or grouped Network Function or slice identifier; and (vii) a token issuance timestamp indicating a time the access token was issued;
digitally sign the access token; and
transmit the access token to the NF Service Consumer.

2. The NRF of claim 1, wherein the claims further comprise claims indicative at least one of an NFSetID as an identifier of a set of authorized producer NF instances or a slice-identifier list identifying a network slice that the NF Service Consumer is authorized to access.

3. The NRF of claim 1, wherein the processor configures the NRF to verify that input parameters in the access token request match with corresponding parameters in a public key certificate of the NF Service Consumer or in an NF profile of the NF Service Consumer.

4. The NRF of claim 1, wherein the processor configures the NRF to:
verify at least one of a slice or network-segment identifier of the NF Service Consumer; and
determine whether restrictions exist on the NF Service Consumer to access services of a specific NF type of a NF Service Producer dependent on slices for which the NF Service Producer offers services.

5. The NRF of claim 1, wherein the processor configures the NRF to include a list of at least one of S-NSSAIs or NSI IDs for expected NF Service Producer instances in the claims of the access token.

6. The NRF of claim 1, wherein the processor configures the NRF to, during processing an NFDiscoveryRequest, cross-verify, directly or indirectly, a requesterSnssais attribute or functionally equivalent slice-identifier attribute with a Single Network Slice Selection Assistance Information (S-NSSAI) attribute in an NFProfile of the NF Service Consumer.

7. The NRF of claim 6, wherein the processor configures the NRF to validate at least one of a slice or network-segment identifier requested for discovery against an allowedSnssais attribute in an NFProfile of target NFs.

8. The NRF of claim 6, wherein the processor configures the NRF to:
log NFDiscoveryRequests and outcomes thereof; and
trigger at least one of an alert or other automated mitigation action in response to detecting at least one of anomalies or patterns indicative of potential bypass attempts.

9. The NRF of claim 1, wherein the processor configures the NRF to maintain in the memory a Token Revocation List (TRL) that records identifiers of revoked access tokens.

10. The NRF of claim 9, wherein the processor configures the NRF to:
receive an NFUpdate Application Programming Interface (API) call from a particular NF Service Producer to revoke access for a particular NF Service Consume; and
mark an existing access token as revoked in the TRL in response to reception of the API call.

11. The NRF of claim 9, wherein the processor configures the NRF to permit NF Service Producers to periodically update local copies of the TRL in the NF Service Producers or query the TRL in the NRF in real-time to verify revocation status of an existing access token before granting service access.

12. The NRF of claim 1, wherein the processor configures the NRF to:
verify parameters in the access token request;
determine relative timing between the token issuance timestamp and a last authorization update timestamp that indicates a time of a most recent update to at least one of the NF Service Consumer or a NFService profile of the NF Service Consumer; and
in response to at least one of failure of verification of the parameters in the access token request or the token issuance timestamp predating a last authorization update timestamp, not process the access token request and indicate to the NF Service Consumer to re-authenticate.

13. The NRF of claim 1, wherein the processor configures the NRF to check whether the NF Service Consumer is able to serve a slice that is included in allowed slices for the NF Service Producer of a specific NF type.

14. The NRF of claim 1, wherein the processor configures the NRF to include additional scope information in the claims that include allowed resources and allowed actions on the allowed resources.

15. The NRF of claim 1, wherein the processor configures the NRF to at least one of:
verify that the NF Service Consumer is authorized to access the services from the NF Service Producer before generating the access token; or
notify affected NF Service Producers when tokens associated with services of the affected NF Service Producers are revoked.

16. The NRF of claim 1, wherein the processor configures the NRF to:
authenticate the NF Service Consumer;
authorize a discovery request in response to a determination that the NF Service Consumer is not attempting to bypass restrictions by forging or manipulating requesterSnssais or S-NSSAI attributes; and
in response to a determination that the NF Service Consumer is not authorized, not issue the access token to the NF Service Consumer and send a reply based on OAuth 2.0 error response.

17. An apparatus of a Network Repository Function (NRF), the apparatus comprising a memory configured to store access tokens and a processor, the processor to configure the NRF to:
receive, from a Network Function (NF) Service Consumer, an access token request for accessing services of an NF Service Producer for a specific Network Function Type (NFType), the access token request including NFInstanceID that is an identifier for a NF and NFSetID that is an identifier of a set of NFs; and
generate, in an access token, an authorizedNFInstances field that lists NFInstanceIDs of producer NFs authorized for access by a requesting NF Service Consumer to permit an NF Service Producer to verify the authorizedNFInstances field in the access token to ensure the NFInstanceID of a service request matches one of the NFInstanceIDs in the access token and reject the service request in response to a determination that the NFInstanceID of the NF Service Producer does not match any of the NFInstanceIDs in the authorizedNFInstances field.

18. The NRF of claim 17, wherein the access token further includes an authorizedNFSetID field in response to the access token request pertaining to a specific NFSet, to permit the NF Service Producer to verify an NFSetID of the NF Service Producer against the authorizedNFSetID in the access token.

19. A non-transitory computer-readable storage medium that stores instructions for execution by one or more processors of an apparatus of a Network Repository Function (NRF), the instructions, when executed, cause the NRF to:
receive an NFDiscoveryRequest from a network function (NF) Service Consumer, the NFDiscoveryRequest including a requesterSnssais attribute that indicates Single Network Slice Selection Assistance Information (S-NSSAIs) served by the NF Service Consumer and an sNssais attribute that indicates S-NSSAIs to be discovered by the NF Service Consumer;
cross-verify the requesterSnssais attribute with an sNssais attribute in an NFProfile of the NF Service Consumer;
validate the S-NSSAIs requested for discovery against an allowedSnssais attribute in an NFProfile of a target NF, the allowedSnssais attribute that indicates which S-NSSAIs the target NF is permitted to serve or be accessed by;
authorize the NFDiscoveryRequest based on cross-verification and validation to permit the NF Service Consumer to discover the target NF based on service capabilities and permissions of the NF Service Consumer; and
log the NFDiscoveryRequest and outcome.

20. The non-transitory computer-readable storage medium of claim 19, wherein the instructions, when executed, cause the NRF to trigger an alert for further investigation upon detecting anomalies or patterns indicative of potential bypass attempts.
